(19) United States
(12) Patent Application Publication
(10) Pub. No.: US 2006/0238018 A1
(43) Pub. Date: Oct. 26, 2006

(54) External truck safety wheel

(76) Inventor: Robert Leonard Sample, LaFayette, GA (US)

Correspondence Address: ROBERT LEONARD SAMPLE, 1249 S. Burnt Mill Rd., LaFayette, GA, 30728, US

(21) Appl. No.: 11/110,119

(22) Filed: Apr. 20, 2005

(51) Int. Cl. B60B 11/10

(52) U.S. Cl. 301/40.2

(57) ABSTRACT

This invention is a safety wheel for 18-wheel trucks and is bolted to their steer/drive wheels using the existing studs and nuts. It is made from a ⅜″ steel disc and a smaller secondary ⅜″ steel disc with the same external diameter, the periphery being supported by a ⅜″ steel ring and by ⅜″ steel triangular braces The extreme outside of the device is covered by a hard rubber “tire”. The diameter of the safety wheel is 4″ less than the diameter of the truck tire, and in the event of a blowout, the safety wheel only allows the truck wheel to drop 2″ instead of going flat, thereby facilitating the driver to maintain the control necessary and helping to prevent the truck from rolling over or swerving into the on-coming traffic.

### BACKGROUND OF THE INVENTION

The present invention relates to safety wheel devices. Over the years, there have been quite a few safety devices invented. However, most of these have been for internal devices There have been several that relate to external devices. We will concentrate on these, as this invention is an external device.

Several prior art devices are known about, that enable a vehicle that sustains a loss of tire air pressure, either because of a puncture, or because of a blowout, to proceed to a safe place to repair, or to replace, the involved tire.

However, many of them are very complex, or they affect the external aspect of the tire rim making a generally unaesthetic rim device. Because of this, such devices have had only limited acceptance.

For example, GB Patent 960323, GB Patent 967397 and FR Patent 1408477 disclose devices for spare rims which are mechanically complicated and expensive to manufacture and maintain. Other devices, such as the rim devices disclosed in U.S. Pat. Nos. 2,019,120 and 3,208,798 disclose rim devices which include one or two externally mounted side support steel ring members attached to the rim, such that upon tire deflation, the supporting rings engage the ground surface to provide support for the wheeled vehicle.

Other support devices are found in U.S. Pat. No. 5,000,518 which relates to an annular ring attached to the rim and having an elastomer mounted to the end thereof, U.S. Pat. No. 1,766,393 which has an annular ring with a wedging groove having an elastomer thereon attached to the rim, and U.S. Pat. Nos. 2,203,774, 2,354,444 and 2,670,994 all of which have grooved peripheral annular devices attached to the rim that retain the elastomer to the extended end of the annular device to engage the road surface during the run-flat condition.

Argentinean Patent Application No. P010101027 also refers to a spare rim to be permanently used next to the main rim.

A Japanese Patent No. WO 88/04996 issued to Tadashi Takeuchi is for an auxiliary safety device for the tire of an automobile, which is formed so that, when the tire of the automobile is punctured while the vehicle is moving, the vehicle can be driven safely for a short distance to a safe place to repair or to change the tire. The characteristics of the device reside in that a disc type member having a diameter larger than the outer diameter of the wheel body and a diameter less than the outer diameter of the tire, and a suitable level of strength is provided so as to extend in parallel with the wheel body. Owing to this disc type member, the weight of this portion of the vehicle is supported even with a flat.

German Patent No. DE 3928553A issued to Takeuchi started with the same design as the preceeding design and progressed to a completely different design. Both inventions were for automobiles and both required modifications of the vehicle wheel/rims. It is very doubtful if they could with-stand the tremendous forces involved with a blowout on the steer/drive wheel of a large 18-wheel truck.

### SUMMARY OF THE INVENTION

One object of the invention is to use the present wheel, that is, no modification in the vehicle wheel is needed. This invention is a unit in itself.

This invention uses 2 disc type steel members, having a diameter smaller than the outer diameter of the vehicle tire and a greater diameter than the wheel body member.

It also uses a ⅜″×2¾″ steel ring on the outer periphery of the disc type members to support them and to form a base for the rubber foot.

It is also reinforced by triangular steel braces so it is able to adequately support the tremendous force in the event of a blowout of the steer/drive wheel tire of a large truck.

It allows the wheel to drop only 2″ instead of going flat, thereby facilitating the driver to maintain control and help prevent a roll-over or from swerving into on-coming traffic.

### DESCRIPTION OF THE DRAWINGS

For the purpose of facilitating an understanding of the present invention, there is in the accompaning drawings, a preferred embodiment of the present invention, from which an inspection of, when considered in connection with the following description, the invention, its construction and operation and some of its advantages may be readily understood and appreciated.

FIG. 1 is a perspective view of the invention.

FIG. 2 is a side view of the invention.

FIG. 3 is a cross-sectional view with the invention attached to the vehicle wheel showing the tire inflated.

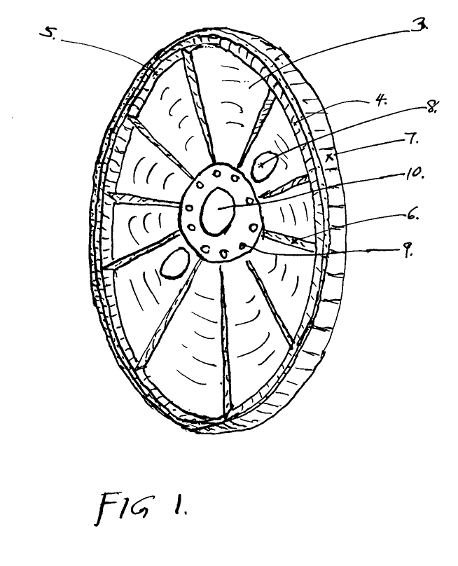

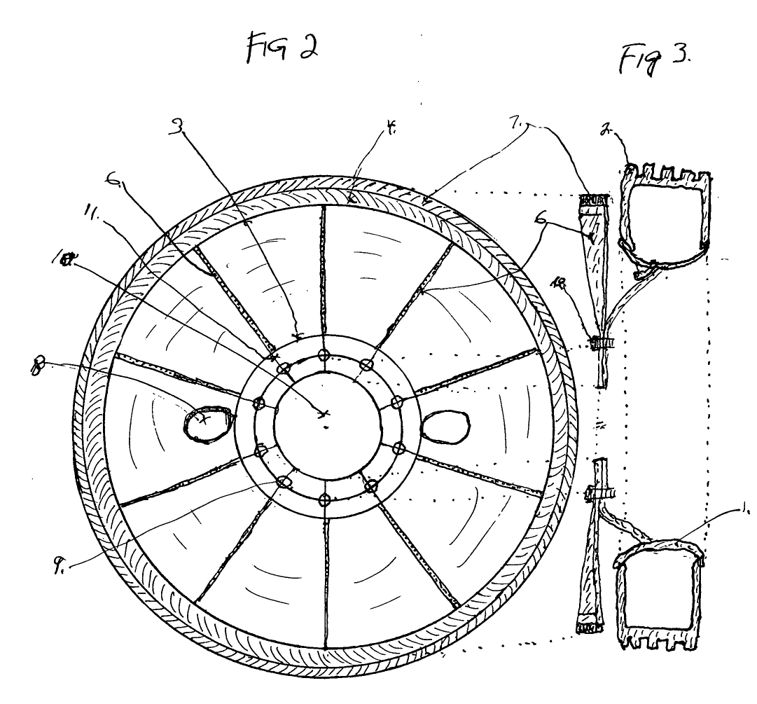

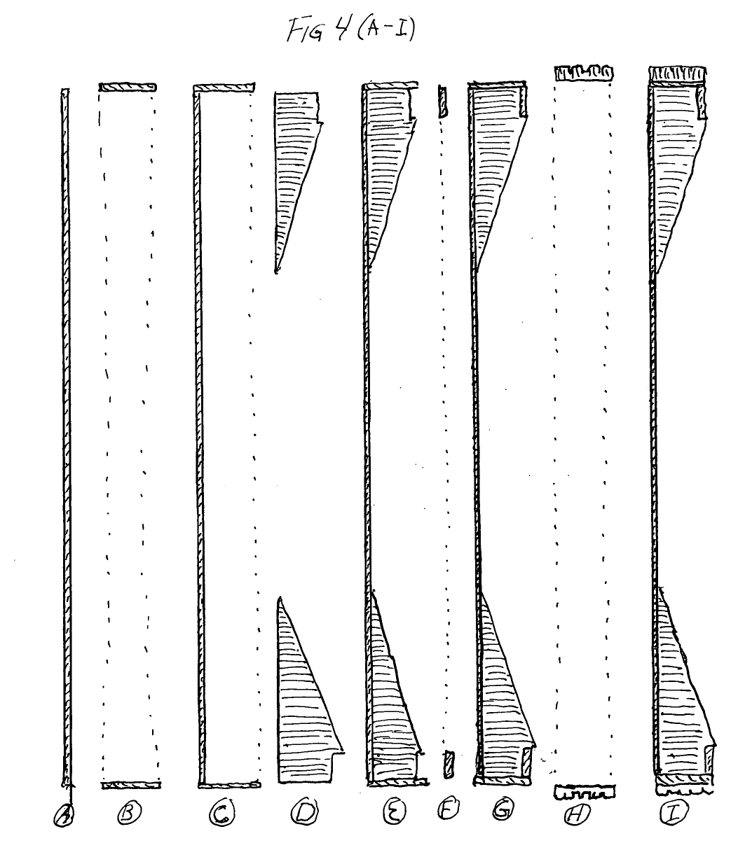

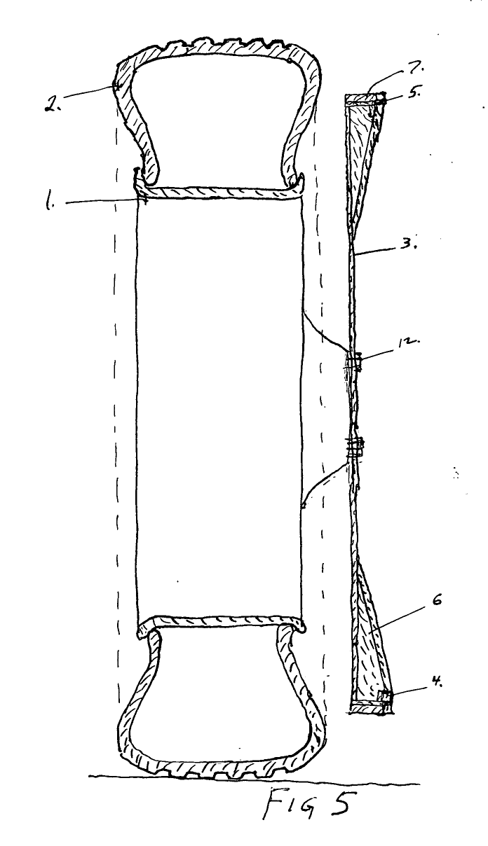

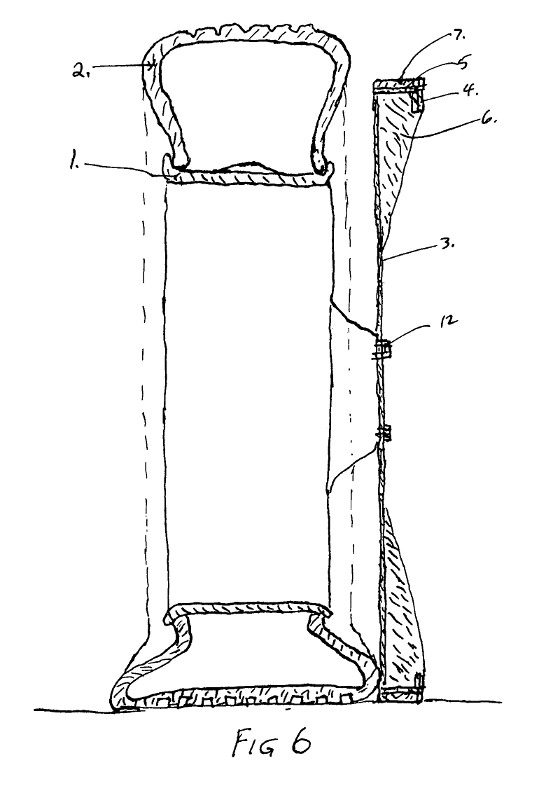

FIGS. 4 (A-I) show cross-sectional constructional views of the invention.
A. shows the ⅜″×34″ diameter steel main disc.
B. shows the ⅜″×2¾″×34″ inside diameter steel ring.
C. shows the main disc with the ring attached.
D. shows the triangular braces individually.
E. shows the triangular braces attached to the main disc and to the ring.
F. shows the secondary ⅜″×1.5″×34″ diameter steel disc individually.
G. shows the secondary disc attached to the previous assembly above.
H. shows the ⅝″×2¾″×34⅜″ inside diameter hard rubber tire.
I. shows the completed invention with the hard rubber tire attached.

FIG. 5 a cross-section of the tire fully inflated with the invention attached.

FIG. 6 shows a cross-sectional view with the tire having lost air pressure and the safety wheel supporting the tire/wheel so it does not go flat, and it can be driven.

### REFERENCE NUMERALS USED IN THE DRAWINGS

1. Truck wheel rim
2. Truck tire
3. Main disc, ⅜″×34″
4. Secondary disc, ⅜″×1.5′×34″
5. Steel ring, ⅜″×2.75″×34″ inside diameter
6. Triangular braces, ⅜″×2.75″×9″
7. Hard rubber tire, ⅝″×2.75″×34.75″ inside diameter
8. Oval aperture 3.5″×4.5″ for valve access and for balance
9. Holes for wheel studs
10. 5.5″ cutout for axle access
11. Radii for position of triangular braces, 36 degrees apart
12. Lug nuts

### DETAILED DESCRIPTION OF THE INVENTION

This invention is for trucks, buses, motor-homes and the like.

This device is a disc type device and consists of:
1. a main ⅜″ steel disc with a diameter 6″ less than the diameter of the truck tire.
2. a secondary ⅜″×1½″ steel disc with the same diameter as the main disc.
3. a ⅜″×2¾″×34″ (inside diameter) steel ring.
4. triangular ⅜″×2¾″×9″ steel braces.
5. a ⅝″×2¾″×34¾″ (inside diameter) hard rubber foot.

For assembly:
1. place the main disc flat on a bench.
2. scribe 3 concentric circles from the center with diameters of 5½″, 11¼″, 14″.
3. next, 10 radii, 36 degrees apart are scribed, from the center.
4. next, between two of the radii, and beginning ½″ distal to the 14″ scribed circle, an oval 3½″×4½″ laterally, is scribed and cut out. This is for valve stem access.
5. next, another oval of the same dimensions is scribed, 180 degrees from the first oval, and is cut out. This is for balance.
6. next, the 5½″ scribed circle is cut out. This is for axle access.
7. where the radii bisect the 11¼″ circle, 1¼″ holes are drilled. These are for the wheel studs to protude through, to mount the safety wheel to the vehicle.
8. next, the ⅜″×2¾″ ring is welded to the outer edge of the main disc and radiating laterally on the scribed side of the main disc.
9. next, the triangular braces are welded to the under side of the ring and along the radii.
10. next, the secondary disc is welded to the under outer portion of the ring, and to the edge of each of the triangular braces.
11. next, the rubber “tire” is secured to the outer surface of the ring by adhesive and by bolts through the “tire” and the ring, in the middle, half way between each of the radii.
12. After painting and balancing, it is ready for mounting on the vehicle.

NOTE: There is a critical measurement. All wheels are not the same.

Measure the diameter of the stud circle, that is, from the center of one stud to the center of the opposite stud. It has to be exact. It will be from 10⅛″ to 11¾″. (In this particular device, it is 11¼″). All other measurements are the same as stated.

What I claim is:

1. The characteristics of the particular construction of the device reside in that a disc type member having a diameter less than the outer diameter of the vehicle tire, and a diameter greater than the diameter of the wheel body and with its heavier construction with its triangular braces, is of sufficient strength to support the weight of this portion of the truck in the event of a blowout, thereby facilitating the driver to maintain control and helping to prevent a rollover or swerving into on-coming traffic.

2. It allows the wheel to drop only 2″ in the event of a blowout.

3. It does not require any wheel modification.

4. It is easily mounted.

5. It is a complete unit in itself.

6. It can easily be transferred to another vehicle of similar tire and wheel diameter.
